(19) United States
(12) Patent Application Publication
(10) Pub. No.: US 2008/0227611 A1
(43) Pub. Date: Sep. 18, 2008

(54) SYSTEM AND METHOD FOR CREATING A CONTINUOUS STREAM OF ENVELOPES

(75) Inventors: Glenn Aspenns, Cincinnati, OH (US); Kevin Conwell, Fairfield, OH (US); Matt Adams, Mason, OH (US)

Correspondence Address: SHOOK, HARDY & BACON, L.L.P.;(C/O INTERMEC), INTELLECTUAL PROPERTY DEPARTMENT, 2555 GRAND BLVD., KANSAS CITY, MO, 64108, US

(73) Assignee: INTERMEC IP CORP., Everett, WA (US)

(21) Appl. No.: 11/774,814

(22) Filed: Jul. 9, 2007

Related U.S. Application Data
(60) Provisional application No. 60/894,747, filed on Mar. 14, 2007.

(51) Int. Cl. B31B 1/00

(52) U.S. Cl. 493/267; 493/186

(57) ABSTRACT

A system and method is provided for creating a continuous stream of envelopes. Envelopes are constructed in a manner that uses existing presses and manufacturing equipment to create a stream of envelopes that are connected together. The envelopes are created from the joining of two or more layers of materials and can be shaped into various forms. The stream of envelopes may be printed using existing industrial printers in a continuous process. Subsequently, the stream of envelopes can be separated into individual envelopes.

### CROSS-REFERENCE TO RELATED APPLICATIONS

This application claims the benefit of U.S. Provisional Application 60/894,747 filed Mar. 14, 2007.

### STATEMENT REGARDING FEDERALLY SPONSORED RESEARCH OR DEVELOPMENT

Not applicable.

### TECHNICAL FIELD

The present invention relates to developing a process for creating a continuous stream of envelopes during the manufacturing process. More particularly, the present invention creates a method for manufacturing a particular type of envelope using conventional devices.

### BACKGROUND OF THE INVENTION

Today, available compact disc (CD) or digital video disc (DVD) envelopes are constructed as individual pieces. This results in stacks of envelopes being created which cannot be used with other devices such as a thermal printer which requires a continuous stream of material. The current process of manufacturing envelopes involves folding the material, applying an adhesive, and folding the material again. Although the manufacturing process for envelopes varies, the typical process includes a multiple cut and fold process. Subsequent to this process, a customer has to determine how to print information on the envelopes in a separate process. A secondary marking method is needed to print on the envelope. In many cases, labels are printed in a secondary process and those labels are manually applied to the envelopes. This secondary marking method or process requires additional materials, additional inventory, and an additional manufacturing process. Therefore, in a typical industrial process, the steps described above for making an envelope and printing on it are incompatible with industrial printers which direct an image onto the media at a high velocity and high volume.

Additional concerns that customers have with the abovementioned process are the appearance of the packaging with the envelope and the labeling. Customers usually want to establish a particular look for their packaged material and a labeled envelope might reduce their desire. In addition, the customer is very concerned about the weight of the complete envelope with its contents, especially for a customer in the mail-order business. The addition of a label could greatly impact costs. Furthermore, customers want to reduce manufacturing times in order to get their product to the market faster. A multi-step process of creating an envelope followed by manual procedures would greatly increase the manufacturing time and cost to the customer.

### SUMMARY OF THE INVENTION

The present invention generally relates to a system and method for manufacturing envelopes and manufacturing a particular type of envelope. In particular, the present invention creates an envelope in a manner that could be manufactured on a standard or conventional equipment that is tailored to a media that is used. In addition, the present invention creates a series of envelopes in a continuous stream from a stock of material. The envelopes are maintained in a stream such that they are fed into a printer for continuous printing on each envelope.

In a first aspect, a method for creating envelopes during a manufacturing process includes applying an adhesive to a first layer of a first material to create an adhesive area. The first layer of the first material is joined to a second layer of a second material. The adhesive area seals the first layer and the second layer. The adhesive area is patterned such that the first layer and the second layer contain a space to hold an item. Information is printed on at least the first layer or the second layer. The steps above are repeated in a continuous form, but not necessarily in an order, to create envelopes.

In another aspect, an envelope for holding a disc-shaped object is provided that includes a first material and a second material joined together to form an enclosure. A first portion of the enclosure contains a first linear-shaped side of the first material and the second material joined together. A second portion of the enclosure contains a second linear-shaped side of the first material and the second material joined together. The first portion and the second portion are located opposite of each other. A third portion of the enclosure contains an arc-shaped side of the first material and the second material joined together. Each end of the third portion is substantially respectively connected to the first portion and the second portion. A fourth portion of the enclosure is substantially connected at each end respectively to the first portion and the second portion to form an opening to access the inside of the enclosure. The fourth portion is located opposite to the third-portion.

In yet another aspect, a system for manufacturing a series of envelopes in a continuous stream is provided that includes placing an adhesive intermittently on a first stream of a first material. The placement of the adhesive creates an intermittent void when the first material comes in contact with another material. The first material is pressed against a second stream of a second material with the adhesive located between the first material and the second material to form a first series of connected enclosures in a third stream. Each enclosure is shaped to create a second series of connected envelopes in the third stream.

In yet another aspect, a method for creating envelopes during a manufacturing process includes applying an adhesive to a first layer of a first material to create an adhesive area. The first layer of the first material is joined to a second layer of a second material. The adhesive area seals the first layer and the second layer. The adhesive area is patterned such that the first layer and the second layer contain a space to hold an item. The steps above are repeated in a continuous form, but not necessarily in an order, to create envelopes.

### BRIEF DESCRIPTION OF THE SEVERAL VIEWS OF THE DRAWINGS

The present invention is described in detail below with reference to the attached drawing figures, wherein:

FIG. 1 is a block diagram of a laminated enclosure suitable for use in implementing an embodiment of the present invention;

FIG. 2 is a block diagram of a sectional view of an exemplary series of envelopes created during an implementation of an embodiment of the present invention;

FIG. 3 is a block diagram of a connected envelope with printed information;

FIG. 4 is a block diagram of an illustration of an exemplary single envelope holding an inserted disc object;

FIG. 5 is a block diagram of another sectional view of an exemplary series of envelopes with a closure tab created during an implementation of an embodiment of the present invention; and

FIG. 6 is a process for creating a set of envelopes during an implementation of an embodiment of the present invention.

### DETAILED DESCRIPTION OF THE INVENTION

The present invention provides a system and method for manufacturing envelopes and manufacturing a particular type of envelope. In an embodiment of the present invention, envelopes are created in a continuous roll or a fanfold to enable them to be used in an industrial printing process. The present invention provides manufacturing efficiencies by streamlining the steps involved in making and printing envelopes. This construction of the envelopes may aid the automated insertion of content into the envelopes. It may also allow a more secure retention of contents such as a CD or DVD while maintaining ease of use.

### Creating a Continuous Stream of Envelopes

The present invention creates an envelope that can be imaged on a conventional thermal printer. The envelope can functionally protect contents such as a CD or a DVD during a standard mailing process. In an embodiment of the present invention, thermal printing can occur on a continuous web of envelopes. This manufacturing process eliminates a secondary process of printing and applying a standard pressure sensitive label to an envelope, such as one containing a CD or a DVD. Because of the construction of the envelopes, various sizes and shapes may be created depending on the implementation of the embodiment of the present invention.

The construction of the envelopes can be made with existing equipment from a number of vendors and from commonly used materials. In an embodiment, the finished product is a continuous stream of envelopes that can be fed into an industrial printer such as a thermal printer or fed into other equipment designed to accept product in a continuous form rather than in individual pieces. An embodiment of the present invention may implement manufacturing processes such as rotary die or flatbed. The embodiment may also include an adhesive being applied to materials with common methods such as flexography printing, offset printing, or gravure printing. Alternative methods of adhesive application may also be implemented such as NORTON systems or transfer tapes. NORTON is a trademark of the Norton Company and Saint-Gobain Abrasives, both of Worcester, Mass.

A set of benefits of the present invention is minimal adjustment that can be employed to standard production methods for printing and laminating, potentially yielding improved speed compared to folded envelopes. In addition, the present invention reduces the complicated manufacturing time and eliminates the need for specialized equipment.

To further describe the present invention, several figures will be discussed in detail below.

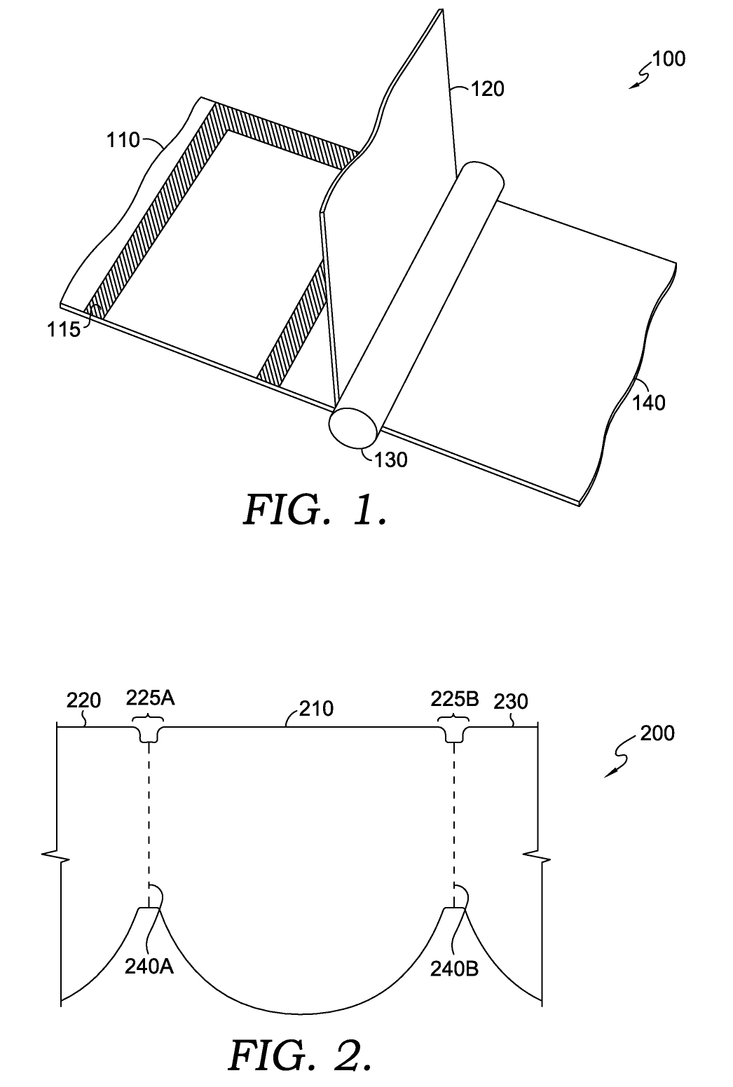

In FIG. 1, a laminated enclosure 100 is shown during a manufacturing process. The enclosure may be constructed by applying an adhesive area 115 onto a first layer 110 of the construction. After application of adhesive area 115, a second layer 120 can be laminated to first layer 110 at roller 130. Roller 130 represent a type of press that can be found in various manufacturing equipment. Adhesive area 115 is patterned to create a void or space between first layer 110 and second layer 120. This void or space can be filled with items such as a CD or a DVD. It can also be filled with other items, particularly for items that can be mailed. First layer 110 and second layer 120 may be constructed from the same or different materials depending on the embodiment that is implemented.

Adhesive area 115 may be constructed from various materials. An exemplary adhesive can vary but in some embodiments is preferably a cross-linked construction that can harden in a short time after printing and laminating has occurred to ensure that the adhesive does not transfer to the contents of the envelope. An exemplary adhesive can be one that is pressure-sensitive. FIG. 1 illustrates an embodiment of an adhesive area 115 that comprises three segments forming two sides and a foot of an enclosure. Certain applications, for example, the enclosing of an optical disc advantageously provide area 115 as contiguous segments thus forming a barrier to dust and sand, which may degrade an optical reading surface. Area 115 can vary widely without departing from the spirit of the invention. Some embodiments make use of a foot which is arc shaped, or sides which are rounded, or conform to packaging requirements for the object to be inserted in the enclosure. Some embodiments save material by varying the width of the adhesive segment for various reasons. Some embodiments lay down discontiguous segments to form the sides and bottom of the enclosure.

By means of die-cutting the series of enclosures 100 depicted in FIG. 1 are shaped into a series of envelopes. The envelopes can be designed to match the size and shape of an intended content. For example, one or both sides of the envelope can be rounded to mimic a CD or a DVD contained therein as shown in FIG. 2 or customized for decorative or functional effect. In FIG. 2, a partial view 200 of cut envelopes 210, 220, and 230 is shown. FIG. 2 represents the results after cutting enclosures 100 in FIG. 1. As shown in FIG. 2, envelopes 210, 220 and 230 are connected together after being constructed on a press or similar equipment. Each envelope contains a space to hold content. At this point of the manufacturing process, the envelopes are connected together in order to facilitate ease of use with other equipment such as a thermal printer. Between each envelope, notches 225A and 225B can be found. These notches act as guide for equipment. For example, notches 225A and 225B may guide a printer to determine the start and stop process for printing information on envelopes 210, 220, and 230. Notches 225A and 225B may also indicate a location where two envelopes are joined together. This location may further be shown by seams 240A and 240B. Seams 240A and 240B can be used to determine where envelopes 210, 220, and 230 should be cut or separated. For example, the individual envelopes can be perforated at seams 240A and 240B to ease separation, or the stream of connected envelopes can be fed through a cutter after printing, filling, etc. to separate into individual envelopes.

For implementing an embodiment of the present invention, various materials can be used to construct envelopes 210, 220, and 230. An exemplary set of materials for construction may be a lightweight, tear-resistant, non-abrasive material that is also compatible with high-quality printers. The use of such materials may vary but can be selected based on an ability to protect contents. Some exemplary materials may include polypropylene, polyethylene, TYVEK of the E. I. du Pont de Nemours and Company of Wilmington, Del., or other film materials. For envelopes with low durability requirements, paper may also be used. Materials can be printable with direct thermal, thermal transfer, inkjet, impact, or other forms of imaging technology. The material can also be pre-printed or printed on-demand during the manufacturing or customer printing process, or a combination of both. Printing of any type can be on one side or both. For example, during the manufacturing process, printing may be on the inside faces of the finished envelopes. A preferred use for this type of printing can be for coupons, games, codes, or other information that needs to be concealed.

To increase utility of the envelopes, additional layers of materials as described above can be added by repeating the process in FIG. 1 of applying an adhesive and adding a layer. This approach can create multiple cavities for holding contents while allowing individual protection. Padding or stiffening layers can also be constructed from this process to increase protection of contents.

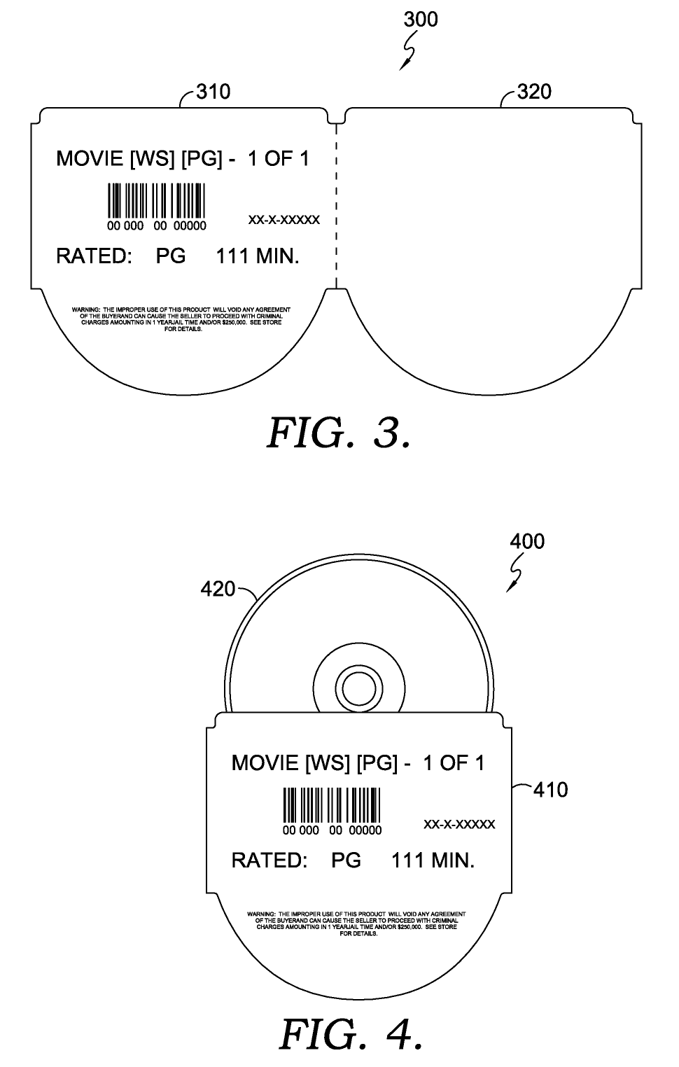

Turning now to FIG. 3, an illustration 300 of connected envelopes 310 and 320 are shown. FIG. 3 is similar to FIG. 2 except envelope 310 illustrates printed information. For example, during the manufacturing process, printed information can be added before, during, or after the construction process of the envelopes. In FIG. 3, a DVD envelope is created with printed information provided about the DVD movie. In FIG. 4, an illustration 400 of an individual envelope 410 is shown after it has been separated from other envelopes created as a stream of envelopes during the manufacturing process. Envelope 410 contains a DVD 420. Printed information about a movie contained on DVD 420 is provided on envelope 410. As shown in FIG. 4, envelope 420 has been constructed with three sides sealed with at least two layers of materials leaving a fourth side as an opening for receiving DVD 420. DVD 420 can be manually or automatically inserted into envelope 410 depending on the embodiment implemented in the present invention.

Various designs can be provided for the envelopes described above. The shapes of the envelopes are not limited to the embodiments that have been described. In addition, other items can be added to the envelopes depending on the end-users' intended use. For example, radio frequency identification (RFID) inlays can be added during the construction process to enable tracking of the envelopes. As depicted in the figures, a bar code can be added for various purposes. In another embodiment, a hole may be placed in one or both layers of materials described above to allow physical identification of the contents. This hole can be lined with a clear film to maintain protection while retaining visibility. In yet another embodiment, envelopes may be created where one layer of material is clear or is constructed from a clear film to enable content visibility.

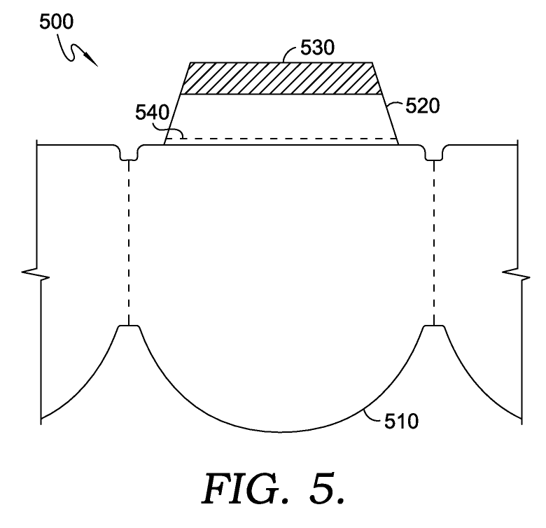

Turning now to FIG. 5, an alternative embodiment of a sectional view of an exemplary series of envelopes 500 is shown with an envelope 510 manufactured with a closure tab 520. In this embodiment, closure tab 520 may be die-cut on the open end of envelope 510 during the manufacturing process. Closure tab 520 may have a transfer adhesive or release liner shown as 530 to enable users to securely seal envelope 510. A perforation 540 can be added to ensure a fold is consistent and accurate. Alternatively, a re-sealable adhesive can be used in 530 for repeated opening and closing. However, closure tab 520 may be constructed without any adhesive and can be used as a detachable proof of purchase or coupon.

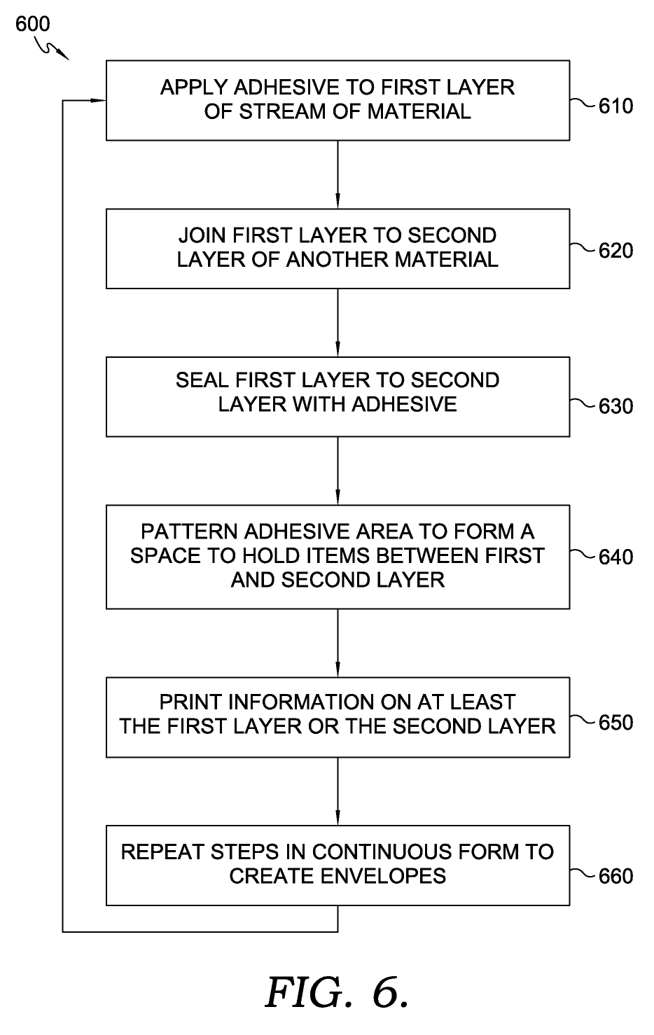

In FIG. 6, a process for creating a set of envelopes is shown in a method 600. Method 600 illustrates an exemplary method for constructing a stream of envelopes. As described above, the construction of the envelopes may take on various forms and are not intended to be limiting in the implementation of the various embodiments of the present invention.

In a step 610, an adhesive is applied to a first layer 110 that comes from a stream of material. In a step 620, first layer 110 is joined to a second layer 120 that also comes from a stream of material. FIG. 1 illustrates the joining of the two layers in step 620 at roller 130. In a step 630, first layer 110 is sealed to second layer 120 with an adhesive identified above as adhesive area 115. In a step 640, the adhesive is patterned over an area to form a space to hold items between first layer 110 and second layer 120. This sealing and adhesive pattern result in a series of pouches identified in 140. In a step 650, print information may be provided on either first layer 110, second layer 120, or both. In addition, print information can be provided on either side of the respective layers since method 600 does not imply order. Step 650 could be implemented before step 610 depending the implementation of the embodiment. In a step 660, the steps of method 600 are repeated in a continuous form to create a stream of connected envelopes.

As a further alternative embodiment of the present invention, an envelope may be over-laminated with a clear film to protect the printed image. The envelope can be sealed with a dry-peel adhesive. A user can cleanly peel the two plies of the envelope apart to read information contained within or to retain for records. In another alternative embodiment, the envelope can have a perforation or other feature to separate the sealed perimeter from the unsealed body of the pouch. In yet another alternative embodiment, the envelopes could be manufactured with a gusset to increase volume of the finished pouch.

The prior discussion is for illustrative purposes to convey exemplary embodiments. The steps discussed in FIG. 6 may be executed without regards to order. Some steps may be omitted and some steps may be executed at a different time than shown. For example, step 650 may be executed before step 640. The point here is to convey that the figures are merely exemplary for the embodiments of the present invention and that other embodiments may be implemented. It will be understood that certain features and sub-combinations are of utility and may be employed without reference to other features and sub-combinations and are contemplated within the scope of the claims.

As shown in the above scenarios, the present invention may be implemented in various ways. From the foregoing, it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A method for creating a set of envelopes during a manufacturing process, comprising:
(a) applying an adhesive to a first layer of a first material to create an adhesive area;
(b) joining the first layer of the first material to a second layer of a second material wherein the adhesive area seals the first layer and the second layer wherein the adhesive area is patterned such that the first layer and the second layer contain a space to hold an item;
(c) printing a first information on a first side of at least one of said first layer and said second layer; and
repeating steps (a), (b), and (c) in a continuous form, but not necessarily in an order, to create the set of envelopes.

2. The method of claim 1, wherein printing said first information comprises printing with a thermal printing process.

3. The method of claim 1, further comprising serializing said envelopes into one of a stack of disjoint cut envelopes, a fanfold, and a continuous roll.

4. The method of claim 1 further comprising (d) printing a second information on a second side of at least one of said first layer and said second layer.

5. The method of claim 1 wherein said first information comprises a field of variable information, varying among two or more envelopes from said continuous form.

6. The method of claim 5 wherein said field of variable information comprises at least one of a serial number, a content title, a playing time, a barcode, a rating, a customer number, and an advisory message

7. The method of claim 1, wherein repeating steps (a), (b), and (c) comprises forming a joined first and second layer into a customized shape for the set of envelopes.

8. The method of claim 2, wherein the set of envelopes includes a substantially arc-shaped side, two linear-shaped sides, and an opening side.

9. An envelope for holding a shaped object, comprising:
a first material and a second material joined together to form an enclosure;
a first portion of the enclosure containing a first area of a first side of said first material and a first area of a first side of said second material joined together;
a second portion of the enclosure containing a second area of said first side of said first material and a second area of a first side of said second material joined together;
the first portion and the second portion located opposite of each other across a void;
a third portion of the enclosure containing a third area of said first side of said first material and a third area of a first side of said second material joined together;
said third portion located proximate to said first portion and to said second portion to substantially form a footing for said enclosure; and
a fourth portion of the enclosure substantially connected at each end respectively to said first portion and said second portion to form an opening to access the inside of the enclosure wherein the fourth portion is located opposite to the third portion across said void.

10. The envelope of claim 9, wherein said third portion is substantially arc shaped.

11. The envelope of claim 9, further comprising a fifth portion of said enclosure comprising a fourth area of said first side of said first material extending beyond said fourth portion to serve as a closure tab.

12. The envelope of claim 11, wherein at least a portion of said first side of said first material receives an adhesive material.

13. The envelope of claim 9, wherein at least one of the first material and the second material contains a set of printed information.

14. The envelope of claim 13, wherein said set of printed information is printed using a thermal printing process.

15. The envelope of claim 14, further comprising a disc.

16. A system for manufacturing a series of envelopes in a continuous stream, comprising:
an adhesive applying component for placing an adhesive intermittently on a first stream of a first material wherein placing the adhesive creates an intermittent void when the first material comes in contact with a second material;
a press for pressing the first material against a stream of said second material with the adhesive located between the first material and the second material to form a first series of connected enclosures in a third stream; and
a cutter for shaping each of the first series of connected enclosures to create a second series of connected envelopes in the third stream.

17. The system of claim 16, further comprising a printer for printing a set of information on at least one of the first stream of material, the second stream of material, the first series of connected enclosures, and the second series of connected envelopes.

18. The system of claim 17 wherein said printer uses a thermal printing process.

19. The system of claim 17, wherein the cutter for shaping each of the first series of connected enclosures comprises the cutter cutting each of the first series of connected enclosures to have an arc edge connected at each end of the arc edge by a set of parallel linear edges which are connected at their respective opposite ends by an opening located opposite the arc edge.

20. The system of claim 19, further comprising an auto-insertion component for automatically inserting discs into said series of enclosures.

21. A method for creating a set of envelopes during a manufacturing process, comprising:
(a) applying an adhesive to a first layer of a first material to create an adhesive area;
(b) joining the first layer of the first material to a second layer of a second material wherein the adhesive area seals the first layer and the second layer wherein the adhesive area is patterned such that the first layer and the second layer contain a space to hold an item; and
repeating steps (a) and (b) in a continuous form, but not necessarily in an order, to create the set of envelopes.

22. The method of claim 21, further comprising serializing said envelopes into one of a stack of disjoint cut envelopes, a fanfold, and a continuous roll.

23. The method of claim 22, wherein the set of envelopes includes a substantially arc-shaped side, two linear-shaped sides, and an opening side.
